(19) United States
(12) Patent Application Publication
(10) Pub. No.: US 2006/0138176 A1
(43) Pub. Date: Jun. 29, 2006

(54) Device for packaging and dispensing a product

(75) Inventors: Pierre-Andre Lasserre, Coubron (FR); Marcel Sanchez, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/288,095

(22) Filed: Nov. 29, 2005

Related U.S. Application Data
(60) Provisional application No. 60/634,288, filed on Dec. 9, 2004.

(30) Foreign Application Priority Data
Nov. 29, 2004 (FR) 0452792

(51) Int. Cl. G01F 11/06; B65D 88/54; G01F 11/30

(52) U.S. Cl. 222/321.8

(57) ABSTRACT

A device for packaging and dispensing a product, such as a cosmetic product. The device includes a container fitted with a dispensing element designed to facilitate discharge of the product from the container, and a dispensing head surmounting the container. The dispensing head includes a mounting member configured to attach to the dispensing element or the container. The dispensing head also includes a diffuser fitted with a dispensing orifice configured to move and actuate the dispensing element so as to cause the product to be released. The diffuser is connected, before a first actuation of the dispensing element, to the mounting member by at least one bridge of material in a position such that the diffuser is not in fluid communication with the dispensing element, the bridge of material being breakable upon first actuation so as to enable fluid engagement of the dispensing element with the diffuser.

### CROSS-REFERENCE TO RELATED APPLICATIONS

This application claims priority to French Application No. 0452792, filed Nov. 29, 2004 and U.S. Provisional Application No. 60/634,288, filed Dec. 9, 2004, the entire content of both of which is hereby incorporated by reference.

### BACKGROUND OF THE INVENTION

1. Field of the Invention

The invention discloses a device for packaging and dispensing a product, for example a cosmetic product. Such a product can be dispensed for example in the form of a cream, a gel, a foam or a spray.

2. Discussion of the Background

The expression “cosmetic product” is understood to mean a product such as defined in Council Directive 93/35/EEC dated 14^{th} Jun. 1993, amending Directive 76/768/EEC for the sixth time.

Generally, a packaging and dispensing device can include a container holding the product to be dispensed fitted with a dispensing element. Such a dispensing element can be a pump or a valve which is surmounted by a diffuser. The diffuser can enable the user to direct the product emerging from the container to a dispensing orifice. It can also serve to control the actuation of the dispensing element to expel a quantity of product from the container.

In a conventional manner, it is possible to use a diffuser substantially cylindrical in shape incorporating a spray orifice, such as that described in U.S. Pat. No. 4,401,240, which is hereby incorporated by reference. The diffuser can be freely mounted on an actuating rod of the actuating element so as to be able to impart an actuating movement thereto. Such a diffuser is relatively easy to manipulate such that it can readily be mounted on the actuating rod on device assembly lines. However, when the diffuser is placed on the actuating rod, the rod may be forced substantially downward and product can escape from the container.

Devices of the “trigger” type also exist such as that described in document JP2000191043, which is hereby incorporated by reference. Such a device incorporates a pump fully integrated into a head equipped with a trigger from which it cannot be separated. Such devices are directly attached to the container so that the risk of actuating the pump plunger when assembling these devices on their container is limited. However, this type of device does not permit the use of different pumps, when it is desired for example to dispense a different dose of product, unless the whole of the head assembly is changed. Moreover, the triggers are of limited aesthetic appeal and do not offer a very wide choice of designs.

Document EP1024094, which is hereby incorporated by reference, describes a dispensing head that includes a body designed to be attached to a container and a pushbutton made in one piece with the body. The body and the pushbutton are connected by bridges of material that are broken before the head is mounted on the container or during mounting thereof. The bridges of material are thus broken before a first use of the device. Such a device can therefore be inadvertently actuated before a first use.

### SUMMARY OF THE INVENTION

One of the objects of the invention, therefore, is to propose a device that does not present, or that reduces, the drawbacks of the prior art.

It is a particular object of an embodiment of the present invention to provide a packaging and dispensing device that includes a dispensing element with a reduced risk of being actuated during assembly of the diffuser on the container.

A further object of an embodiment of the present invention is to provide a dispensing device that enables a relatively viscous product to be sprayed without exerting an unduly large force to actuate the dispensing element while at the same time obtaining a good quality spray.

Another object of an embodiment of the present invention is to provide such a device that is original in appearance, simple to use and economical to make.

A further object of an embodiment of the present invention is to provide a dispensing device that avoids, or reduces the risk of, an inadvertent actuation of the dispensing element that it is designed to control.

In a preferred embodiment, these objects can be achieved, for example, by providing a device for packaging and dispensing a product including:

a container, holding the product, fitted with a dispensing element designed to facilitate discharge of the product from the container;

a dispensing head surmounting the container, including:

a mounting member configured to fix the head relative to the container,

a diffuser, fitted with a dispensing orifice, designed to move the dispensing element thereby actuating it so as to cause the product to be released;

a trigger designed to control actuation of the dispensing element, the trigger being designed to bear on the diffuser so as to move it thereby actuating the dispensing element.

Before a first actuation of the dispensing element, the diffuser can be connected to the mounting member by at least one bridge of material in a position such that, in a preferred embodiment, the diffuser is not in fluid communication with the dispensing element, the bridge of material being breakable upon first actuation so as to enable fluid engagement of the dispensing element with the diffuser.

In a preferred embodiment, the diffuser is not in fluid communication with the dispensing element, which means that there is no leaktight connection between the two components and that product cannot be transferred from the dispensing element to the diffuser without leakage.

Such a position of the diffuser relative to the dispensing element can reduce or limit the risk of actuating the dispensing element during assembly of the dispensing head on the container on the assembly lines, thereby limiting the risks of product leakage.

The trigger can limit the force needed to actuate the pump, which makes the device more convenient to use and simplifies the hand actions required to apply the product. It is therefore possible to spray relatively viscous products such as milks or oils, which require the use of pre-compression pumps to be able to form a good quality spray, in particular one that is composed of fine particles. The trigger also enables the user to easily break the bridge of material on first actuation of the dispensing element by limiting the force needed to effect the break. Relatively solid bridges of material can thus be used to limit the risks of inadvertent breakage, while being easily breakable upon first actuation of the dispensing element by virtue of the lever effect of the trigger.

In another embodiment, a portion of the diffuser designed to be in fluid communication with a portion of the dispensing element can be located, before the first actuation of the dispensing element, at a non-null distance, measured on the lengthwise axis of the dispensing element, from the portion of the dispensing element. For example, after a first actuation of the dispensing element and when the dispensing element is at rest, i.e. when it is not actuated, the diffuser can be in an axial position different from its axial position before first actuation.

In an embodiment, the diffuser can include a sleeve designed to fit in a leaktight manner on an actuating rod of the dispensing element, a lower edge of the sleeve being located above an upper edge of the actuating rod before a first actuation of the dispensing element.

The mounting member can be connected to the diffuser by several bridges of material, in particular four bridges of material.

The diffuser can include a cylindrical skirt having a lower edge, the bridge(s) of material being formed on the lower edge of the cylindrical skirt.

The mounting member and the diffuser can be obtained by moulding in one piece. This reduces the number of parts to be made and hence the manufacturing cost of the device.

The diffuser can be configured to depress the dispensing element on the lengthwise axis of the dispensing element in order to actuate it.

The dispensing element can be a pump, for example. The dispensing element could also be a valve.

The mounting member can be connected to the diffuser by a flexible strip which enables the diffuser to move relative to the mounting member. The diffuser can remain integral with the mounting member, even after having broken the bridges of material upon first actuation.

The mounting member can include a ferrule designed to be attached to a neck of the container or to a fixing skirt securing the dispensing element to the container. The ferrule can be configured, for example, to be snapped onto the neck of the container or onto the fixing skirt securing the dispensing element to the container or, can include a screw thread enabling the head to be screwed onto the neck of the container.

The diffuser can include a cannula which emerges via the dispensing orifice. The cannula can be elongated on an axis different from the lengthwise axis of the dispensing element, for example on a substantially perpendicular axis. The product can thus be dispensed in a relatively precise manner.

The trigger can be obtained by moulding in one piece with the diffuser and the mounting member. The dispensing head can thus be made in one piece, and therefore at lower cost.

The trigger can be connected to the mounting member by a flexible tab.

The trigger can be pivoted on the mounting member, in particular by a first end of the trigger. For this purpose, the first end of the trigger can include two lateral holes designed to delineate a pivot axis, for example an axis substantially perpendicular to the lengthwise axis of the trigger. The two holes can be configured to receive two protruberances provided on the mounting member thereby facilitating a pivoting movement of the trigger relative to the mounting member about the pivot axis.

The trigger can include a second end designed to form a bearing surface to control the actuation of the dispensing element.

The trigger can be configured to depress the diffuser thereby actuating the dispensing element. The trigger can include at least one lug designed to bear on an upper wall of the diffuser. The lug can be configured to fit into a counterpart recess provided on the upper wall of the diffuser. This ensures that the diffuser is correctly positioned during actuation of the dispensing element.

The trigger can include a window traversed by the cannula.

The device can include a locking member designed to limit the movement of the trigger thereby preventing actuation of the dispensing element. The locking member can for example include a rod designed to pass through a slot provided in the trigger, and the rod can include a shoulder on which a portion of the trigger is designed to bear. The rod can in particular be integral with the mounting member and can be obtained by moulding in one piece with the other component parts of the dispensing head. Of course, any other form of locking member can be used.

The container can contain a cosmetic product.

The device is particularly useful for packaging and dispensing a cosmetic product, in particular in the form of a cream, a foam, a gel or a spray.

### BRIEF DESCRIPTION OF THE DRAWINGS

Apart from the arrangements described above embodiments of the present invention can include a certain number of other features which will be explained below, in relation to non-limitative embodiments, described in reference to the attached figures wherein:

FIG. 1 illustrates a perspective view of a packaging and dispensing device according to a preferred embodiment of the present invention;

FIGS. 2 to 4 illustrate different views of the dispensing head of the device illustrated in FIG. 1, before it is mounted on a container;

FIGS. 5 and 6 show a head locking member in two different positions;

FIG. 7 shows a sectional view on VII-VII in FIG. 6;

FIG. 8 shows a sectional view of the device in FIG. 1 before a first use;

FIG. 9 shows a sectional view of the device in FIG. 1 in the process of being used;

FIG. 10 shows a sectional view of the device in FIG. 1 at rest, after having been used at least once; and

FIGS. 11 and 12 illustrate other embodiments of the present invention.

### DESCRIPTION OF THE PREFERRED EMBODIMENTS

The device 1 includes a container 10, made in a thermoplastic material for example. Other material can be used to make the container, and in particular tin plate or aluminium. The container 10 includes a body 11, for example generally spherical in shape and including an open neck 12 wherein a pump 20 of lengthwise axis X is mounted using a fixing skirt 23 attached to the outer wall of the neck 12. The container can alternatively have any other shape, in particular a cylindrical shape.

The pump 20, which is not shown in detail in the figures, can be a standard pump, preferably of the pre-compression type. The pump includes a plunger of which the movement inside the pump body, in one direction, causes the product to be expelled under pressure, and in the other direction, causes product to be drawn into the pump body. Generally, the plunger is held in a position corresponding to the maximum volume of the pumping chamber using a spring. As can be seen in FIGS. 8 to 10, the pump includes an actuating rod 21 which can be displaced on its lengthwise axis by exerting pressure from above to actuate the pump.

The container 10 is surmounted by a dispensing head which can be attached to the pump 20 using a mounting member 30 in the form of a ferrule. The ferrule 30 is secured to the pump, for example with a snap attachment. The ferrule 30 includes for example an annular bead 36 configured to fit under a ring 22 provided on the fixing skirt 23 of the pump. Alternatively, the ferrule 30 can incorporate a bead 36 on its lower edge designed to fit under the lower edge of the fixing skirt 23 of the pump.

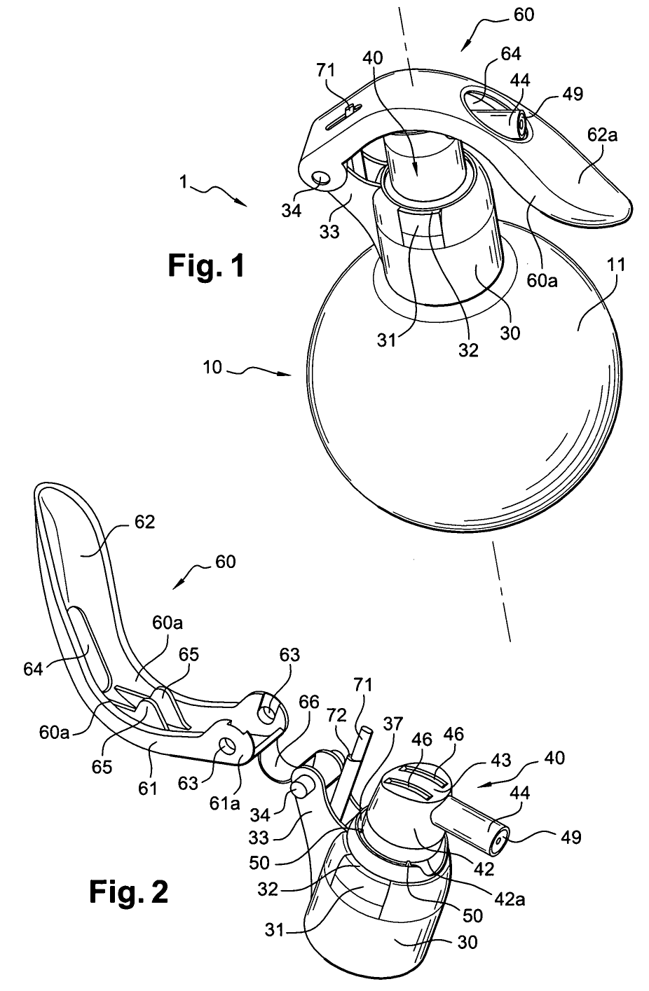

To facilitate the snap attachment of the ferrule 30 to the pump, the ferrule 30 can include two areas of increased thickness 31, diametrically opposite each other, each forming a rim 32 on the outer surface of the ferrule. The two rims 32 thus formed, visible in FIGS. 1 and 2, serve as a bearing surface for the tool used to snap the ferrule onto the pump.

The dispensing head additionally includes a diffuser 40 configured to depress the actuating rod 21 of the pump lengthwise thereby actuating it. The diffuser 40 also delineates a channel 47 designed to convey the product drawn from the container from the actuating rod to a spray orifice 45.

The diffuser 40 includes a sleeve 41 designed to fit directly onto the actuating rod. The sleeve 41 delineates a first portion of the product delivery channel 47. The delivery channel 47 extends into a second portion, oriented transversely to the first, which is delineated by a cannula 44. The cannula 44 is of elongated shape on an axis substantially perpendicular to the lengthwise axis X of the pump, and extends from the sleeve 41 to an end emerging via the spray orifice 45. The end of the cannula 44 includes a nozzle support 48, fitted with a pin also referred to as a “centerpost”, on which a conventional swirl-effect nozzle 49 can be fitted, as can be seen in the figures, the nozzle delineating the spray orifice 45. The presence of the nozzle enables the product to be atomised in the form of a good quality spray.

The diffuser 40 also includes a cylindrical skirt 42 which surrounds the sleeve 41 and which is closed at its upper part by a transverse wall 43. The transverse wall 43 is provided with two straight parallel recesses 46, visible in FIGS. 2 and 4, the function of which will be explained later in the description.

As the diffuser 40 is designed to depress the actuating rod, it must be able to move relative to the ferrule 30, which is itself attached to the container. Provision is preferably made for the cylindrical skirt 42 of the diffuser to present a diameter substantially smaller than the diameter of the ferrule 30 so as to form an annular space 37 between the two parts allowing the diffuser to move downward inside the ferrule.

As can be seen in particular in FIGS. 2 and 4, which depict the dispensing head before it is mounted on the container, the diffuser 40 is connected, before a first actuation of the dispensing element, to the ferrule 30 by at least one bridge of material 50 which connects the lower edge 42a of the skirt 42, to the ferrule 30. In particular, four bridges of material 50 are provided between the two parts. The bridges of material 50 extend transversely to the axis X in the annular space 37. The bridges of material 50 are sufficiently strong to hold the diffuser on the ferrule during assembly of the head on the container but sufficiently weak to be able to break at the first depression of the diffuser 40 actuating the pump 20.

The ferrule 30 and the diffuser 40 are thus obtained by one-piece moulding.

When the head is assembled on the container, the diffuser 40 is in a position such that it is not in fluid communication with the actuating rod 21 of the dispensing element. In particular, the sleeve 43 of the diffuser is above the actuating rod 21, and is flush with the upper end of the actuating rod 21 as can be seen in FIG. 8, without being fitted over it.

The bridges of material 50 thus serve to hold the diffuser at the desired distance from the pump before a first actuation. They additionally form tamper-proof tabs which serve as proof for the user purchasing the device that the device has never been used.

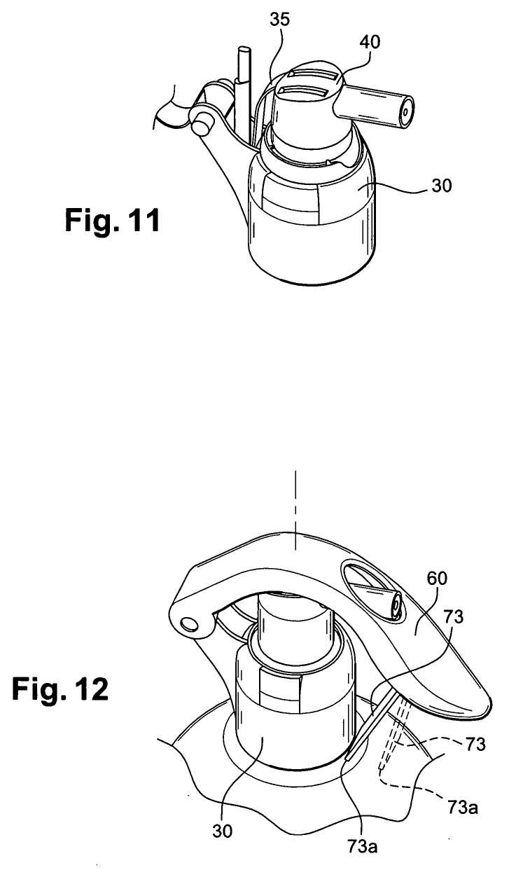

In a variant illustrated in FIG. 11, provision can be made for the diffuser 40 to be additionally connected to the ferrule 30 by a flexible strip 35 which allows the diffuser to move relative to the mounting member. Such a strip 35 serves to keep the two parts integral with each other after the bridges of material 50 have been broken, thereby limiting the risk of losing the diffuser.

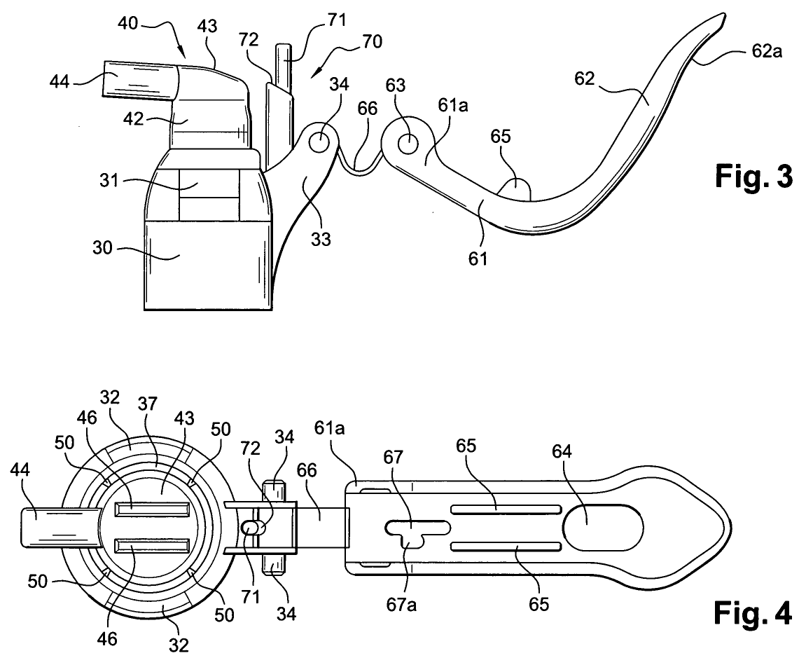

In the example illustrated in FIGS. 1 to 10, a trigger 60 is provided to control the actuation of the pump by depressing the diffuser 40, which itself depresses the actuating rod 21. The trigger 60 is formed by a curved lever arm including two portions 61 and 62 forming an angle between them, the trigger 50 having a lengthwise axis extending in a plane parallel to the axis X. The first portion 61 presents a first end 61a hinged on the ferrule 30 thereby enabling the trigger 60 to pivot about an axis perpendicular to the axis X. In the example illustrated, the first end 61a is hinged on an intermediate member 33, integral with the ferrule 30, which serves to hold the pivot away from the ferrule to allow the pivoting movement of the trigger. In particular, the first end 61a of the trigger includes two lateral holes 63 designed to delineate a pivot axis, in particular an axis substantially perpendicular to the lengthwise axis of the trigger. The two holes 63 are configured to receive two protruberances 34 provided on the intermediate member 33 thereby facilitating a pivoting movement of the trigger relative to the mounting member about the pivot axis.

In the assembled position illustrated in FIG. 1, the first portion 61 extends from the hinge towards and above the diffuser to the curved portion located substantially above the transverse wall 43 of the diffuser. The second portion 62 of the trigger curves down on the other side of the diffuser. In particular, the second portion 62 of the trigger extends from the curved portion, moving away from the diffuser towards the container 10 and terminating at a second end 62a of the trigger. The second end 62a forms a surface on which the user can press to cause the trigger to pivot. The trigger 60 is relatively long thereby optimising the lever effect and therefore the ease of use. In addition, the bearing surface 62a on which an actuating force is exerted is located on one side of a plane passing through the axis X, while the hinge is located on the other side of the plane thereby facilitating actuation of the pump.

As can be seen in FIGS. 2 to 4, two lugs 65 are provided under the portion 61 of the trigger to bear on the transverse wall 43 of the diffuser and facilitate actuation of the pump. In particular, the two lugs are designed to fit into the two recesses 46 provided on the transverse wall 43 of the diffuser. The second portion 62 of the trigger is additionally provided with a window 64 which can be traversed by the cannula 44. The trigger can thus be extended below the cannula.

In the embodiment shown, the trigger 60 is U-shaped in transverse cross-section, i.e. it has a channel running its entire length, the channel being defined by two flanges 60a provided on each edge of the trigger.

The trigger 60 can be made separately from the ferrule 30 or, as in the example depicted in the figures, can be obtained by moulding in one piece with the diffuser and the mounting member. The trigger is in effect connected to the intermediate member 33 of the ferrule 30 by a flexible tab 66.

When the trigger is made independently of the ferrule, the flexible tab 66 is not provided. Preferably a more rigid material than that used to make the rest of the dispensing head is used so as to obtain a relatively strong lever arm that can be easily actuated.

To avoid inadvertent actuation of the trigger, a locking member 70 is provided to limit the movement of the trigger thereby preventing actuation of the dispensing element.

In the example illustrated, the locking member includes a rod 70 which extends parallel to the axis X from the intermediate member 33 to a free end 71 thinner than the rest of the rod 70, a shoulder 72 being provided between the thinner portion and the rest of the rod 70 to serve as a stop for a portion of the trigger.

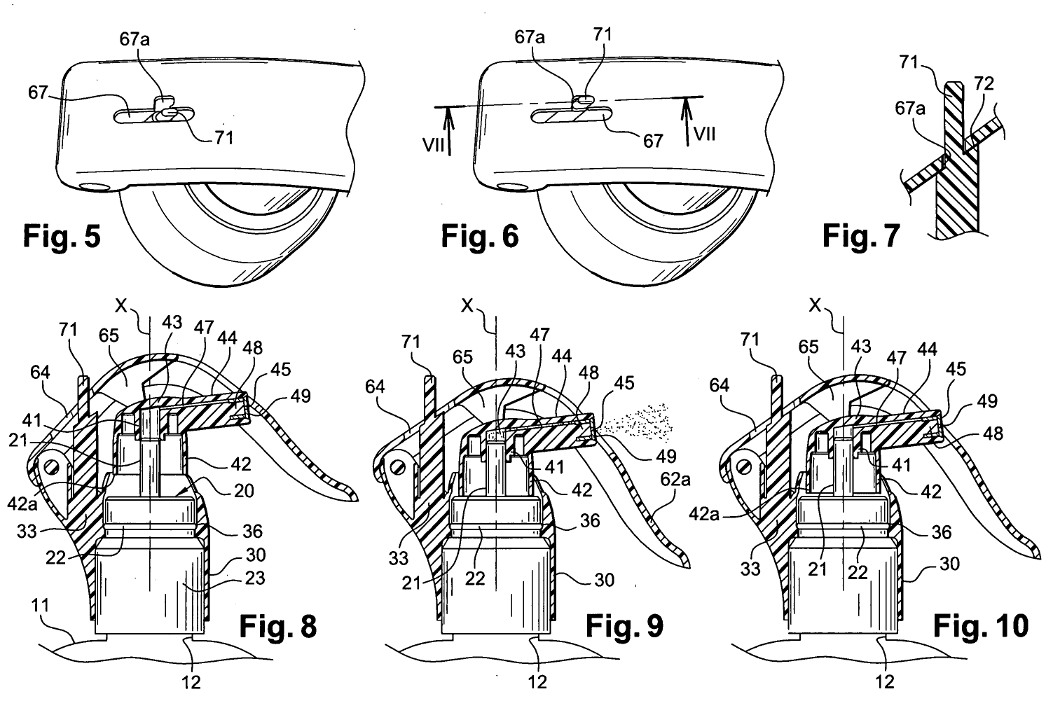

The free end 71 of the rod 70 is configured to pass through a slot 67 provided in the trigger as can be seen in FIG. 5.

The slot 67 extends lengthwise in the first part of the trigger over a sufficient length so that the end 71 of the rod 70 does not prevent the trigger from moving when the trigger is actuated. The slot 67 is widened over a small portion 67a of its length. This portion 67a is designed to receive the free end 71 of the rod 70 when it is wished to lock the device. In this position illustrated in FIGS. 6 and 7, the trigger is abutted against the shoulder 72 of the rod and also against the edges of the trigger 60 delineating the portion 67a of the slot. Thus, when pressure is applied on the portion 62a of the trigger, the latter being abutted against the rod 71, it cannot be displaced sufficiently for the lugs 65 to depress the diffuser 40 and for the actuating rod to be depressed.

The scope of the invention is not exceeded by using any other form of locking member. It is possible for example to use a flap 73 pivoted on the trigger, the flap having a free end 73a designed to bear against the diffuser 40 to lock the trigger, as illustrated in FIG. 12.

To make the device described according to FIGS. 1 to 10, the pump 20 is first mounted in the neck of the container, for example by snapping its fixing skirt 23 onto the outer wall of the neck 12.

In parallel, the dispensing head can be made in one piece by plastic moulding, the diffuser 40 being integral with the ferrule 30 via the bridges of material 50. The presence of bridges of material additionally serves to hold the diffuser in the correct position relative to the ferrule, and particularly relative to the trigger, so that the cannula 44 is correctly positioned to be able to pass through the opening 64 in the trigger.

The trigger is moulded in the open position, as illustrated in FIGS. 2 to 4, the trigger being connected to the rest of the head by the flexible tab 66.

Before mounting the head on the container, the trigger 60 is brought down onto the diffuser 40 and the two protruberances 34 of the intermediate member 33 are inserted into the two holes 63 provided at one end of the trigger so as to form the hinge between the trigger and the ferrule.

The head can thus be attached to the container in this configuration. In particular, the mounting ferrule 30 is snapped onto the fixing skirt 23 of the pump 20 using a clamp which bears on the two edges 32 of the ferrule 30. As can be seen in FIG. 8, once the head is attached to the pump, the sleeve 41 is not in engagement with the actuating rod 21 so that the actuating rod is not liable to be depressed during assembly of the head on the container.

To use the device just described, the user grasps the container 10 and/or the ferrule 30 by one hand and can then actuate the trigger 60 by pressing, with one finger of the hand, on the bearing surface 62a.

On first use, the bridges of material 50 will break under the effect of the pressure exerted by the trigger on the diffuser while the ferrule 60 remains fixed on the container 20. The presence of the recesses 46 in the diffuser associated with the lugs 65 on the trigger ensures that the diffuser, and in particular the cannula, is always correctly positioned relative to the trigger 60, in the case where, for example, the diffuser 40 has rotated relative to the ferrule 30.

When the diffuser 40 is depressed, the product can be sprayed as seen in FIG. 9.

When the diffuser 40 reverts to the rest position as illustrated in FIG. 10, it is in an axial position different from its initial position before a first actuation. In particular, the diffuser 40 is substantially depressed into the ferrule 30 and the sleeve 41 is pushed onto the actuating rod 21. In addition, the lugs 65 are substantially inserted into the recesses 46 thereby preventing the diffuser 40 from rotating relative to the ferrule 30 between two uses.

Furthermore, if it is wished to avoid inadvertent actuation of the pump, the free end 71 of the rod of the locking member can be placed in the portion 67a of the slot, as illustrated in FIG. 6. In effect the rod 70 is sufficiently flexible so that its free end 71 is able to move relative to its base.

In the foregoing detailed description reference is made to preferred embodiments of the invention. It is evident that variants thereto can be proposed without departing from the invention as claimed herebelow.

What is claimed as new and desired to be secured by Letters Patent of the United States is:

1. A device for packaging and dispensing a product comprising:
a container fitted with a dispensing element and;
a dispensing head surmounting the container, said dispensing head comprising:
a mounting member configured to fix the dispensing head relative to the container,
a diffuser fitted with a dispensing orifice, designed to move and actuate the dispensing element; and
a trigger configured to control actuation of the dispensing element, the trigger being configured to bear on the diffuser so as to move said diffuser and thereby actuate the dispensing element;
wherein the diffuser is connected, before a first actuation of the dispensing element, to the mounting member by at least one bridge of material in a position such that the diffuser is not in fluid communication with the dispensing element, the bridge of material being breakable upon first actuation so as to enable fluid engagement of the dispensing element with the diffuser.

2. The device according to claim 1, wherein a portion of the diffuser configured to be in fluid communication with a portion of the dispensing element is located, before the first actuation of the dispensing element, at a non-null distance, measured on the lengthwise axis of the dispensing element, from said portion of the dispensing element.

3. The device according to claim 1, wherein the diffuser can include a sleeve configured to fit in a leaktight manner on an actuating rod of the dispensing element, a lower edge of the sleeve being located above an upper edge of the actuating rod before the first actuation of the dispensing element.

4. The device according to claim 1, wherein the mounting member is connected to the diffuser by several bridges of material.

5. The device according to claim 1, wherein the diffuser includes a cylindrical skirt having a lower edge, the at least one bridge of material being formed on the lower edge of the cylindrical skirt.

6. The device according to claim 1, wherein the mounting member and the diffuser are obtained by moulding in one piece.

7. The device according to claim 1, wherein the diffuser is configured to depress the dispensing element on a lengthwise axis of the dispensing element in order to actuate said dispensing element.

8. The device according to claim 1, wherein the dispensing element is a pump.

9. The device according to claim 1, wherein the mounting member is connected to the diffuser by a flexible strip which enables the diffuser to move relative to the mounting member.

10. The device according to claim 1, wherein the mounting member includes a ferrule designed to be attached to a neck of the container or to a fixing skirt securing the dispensing element to the container.

11. The device according to claim 10, wherein the ferrule is configured to be snapped onto the neck of the container or onto the fixing skirt securing the dispensing element to the container.

12. The device according to claim 1, wherein the diffuser includes a cannula which emerges via the dispensing orifice.

13. The device according to claim 1, wherein the trigger is obtained by moulding in one piece with the diffuser and the mounting member.

14. The device according to claim 13, wherein the trigger is connected to the mounting member by a flexible tab.

15. The device according to claim 1, wherein a first end of the trigger is pivoted on the mounting member.

16. The device according to claim 15, wherein the first end of the trigger includes two lateral holes delineating a pivot axis substantially perpendicular to a lengthwise axis of the trigger.

17. The device according to claim 16, wherein the two lateral holes are configured to receive two protruberances provided on the mounting member thereby facilitating a pivoting movement of the trigger relative to the mounting member about the pivot axis.

18. The device according to claim 15, wherein the trigger includes a second end designed to form a bearing surface to control the actuation of the dispensing element.

19. The device according to claim 18, wherein the trigger is configured to depress the diffuser thereby actuating the dispensing element.

20. The device according to claim 1, wherein the trigger includes at least one lug configured to bear on an upper wall of the diffuser.

21. The device according to claim 20, wherein the lug is configured to fit into a counterpart recess provided on the upper wall of the diffuser.

22. The device according to claim 12, wherein the trigger includes a window traversed by the cannula.

23. The device according to claim 1, further comprising a locking member configured to limit movement of the trigger thereby preventing actuation of the dispensing element.

24. The device according to claim 23, wherein the locking member includes a rod configured to pass through a slot provided in the trigger.

25. The device according to claim 24, wherein the rod includes a shoulder on which a portion of the trigger is designed to bear.

26. The device according to claim 1, wherein said container contains said product.

27. The device according to claim 26, wherein said product is a cosmetic product.

28. A method of dispensing from the device of claim 1, comprising breaking said at least one bridge of material.

29. The method according to claim 28, further comprising placing said diffuser in fluid communication with said dispensing element.

30. The method according to claim 29, wherein the dispensing of said product is in the form of a cream, a foam, a gel or a spray.

31. A device for dispensing a product, comprising:
a dispensing element;
a diffuser;
a mounting member mounted on said dispensing element, said mounting member being coupled to said diffuser by breakable members,
wherein before said breakable members are broken, said diffuser is not in fluid communication with said dispensing element, and after said breakable members are broken, said diffuser is in fluid communication with said dispensing element.

32. The device of claim 31, further comprising a container in fluid communication with said dispensing element.

33. The device of claim 32, further comprising said product in said container.

34. The device of claim 31, wherein after said breakable memners are broken, said dispenser is free to move toward said dispensing element.

35. The device of claim 34, wherein after said breakable members are broken, said dispenser is engaged with said dispensing element.

36. The device of claim 31, wherein said dispensing element includes an actuating rod and, before said breakable members are broken, said dispenser is above said actuating rod.

37. The device of claim 31, wherein said diffuser has an maximum outer diameter smaller than an inner diameter of said mounting element so that said diffuser and said mounting element are separated by an gap.

38. The device of claim 37, wherein said breakable members are bridges across said gap.

39. The device of claim 38, wherein, after said breakable members are broken, said diffuser is free to move inside said mounting element.

40. The device of claim 31, further comprising a pivotable lever coupled to said mounting element and configured to bear on said diffuser.

41. The device of claim 40, wherein said pivotable lever is coupled to said mounting element via a hinge located on one side of a plane passing through a longitudinal axis of said dispensing element, said pivotable lever having a bearing surface on another side of the plane.

42. The device of claim 40, wherein said pivotable lever defines a window through which a portion of said diffuser extends at least when said diffuser is in fluid communication with said dispensing element.

43. The device of claim 40, wherein said pivotable lever comprises:
a first end coupled to said mounting element,
a second end opposite said first end, said second end being a free end, and
a bearing portion located between said first and second ends, wherein said bearing portion is configured to bear against said diffuser.

44. The device of claim 43, wherein said pivotable level is configured so that, when said bearing portion bear against said diffuser on a surface of said diffuser, said first and second ends are below said surface.

45. The device of claim 44, wherein said surface has at least one recess and said pivotable lever has at least one lug configured to fit into said recess.

46. A device for dispensing a product, comprising:
a dispensing element;
a diffuser;
a mounting member mounted on said dispensing element, said mounting member being coupled to said diffuser; and
a pivotable lever coupled to said mounting element and configured to bear on said diffuser,
wherein in a first position, said diffuser is not in fluid communication with said dispensing element, and in a second position, said diffuser is in fluid communication with said dispensing element, and
wherein said pivotable lever defines a window through which a portion of said diffuser extends at least in said second position.

47. The device of claim 46, wherein, in said first position, said mounting member is coupled to said diffuser by breakable members.

48. The device of claim 47, wherein, in said second position, said mounting member is not coupled to said diffuser by said breakable members.

49. The device of claim 48, wherein, in said second position, said diffuser is free to move inside said mounting element.

50. The device of claim 48, wherein said lever has a bearing surface that bears on said diffuser in said second position, and
said lever is curved so that said lever has two opposite ends below said bearing surface when said lever bears on said diffuser.
